(19) United States
(12) Patent Application Publication
(10) Pub. No.: US 2025/0007227 A1
(43) Pub. Date: Jan. 2, 2025

(54) GROUNDING BRUSH ASSEMBLY

(71) Applicant: AKTIEBOLAGET SKF, GOTEBORG (SE)

(72) Inventors: Anthony SIMONIN, Tours (FR); Emmanuel BENEVISE, Monts (FR); Thomas PERROTIN, Saint Roch (FR)

(21) Appl. No.: 18/742,566

(22) Filed: Jun. 13, 2024

(30) Foreign Application Priority Data
Jun. 30, 2023 (FR) 2306926

(51) Int. Cl. H01R 39/39; H01R 39/24; H01R 39/38; H02K 5/14; H02K 11/40

(52) U.S. Cl. CPC H01R 39/39; H01R 39/24; H01R 39/385; H02K 5/145; H02K 11/40

(57) ABSTRACT

A grounding brush assembly includes a grounding brush including a plurality of conductive fibers and a support inside of which the conductive fibers are mounted, and a brush mounting plate rigidly secured to the support of the brush. The mounting plate includes a plurality of centering tabs for centering the support of the brush and a plurality of securing means for rigidly securing the centering tabs to the support, the securing means being distinct from the support and from the centering tabs.

### CROSS-REFERENCE

This application claims priority to French patent application no. 2306926 filed on Jun. 30, 2023, the contents of which are fully incorporated herein by reference.

### BACKGROUND OF THE INVENTION

The present invention relates to the field of grounding devices for controlling the shaft voltage generated in electric motors or machines, and in particular grounding brush assemblies.

In an electric motor or machine, at least one rolling bearing is mounted between the casing of the electric motor or machine and the rotary shaft in order to support this shaft. During operation as the shaft rotates, a difference in electrical potential may arise between the shaft and the casing of the electric motor or machine. Such a difference in electrical potential may generate an electric current between the inner ring of the rolling bearing, which is rigidly secured to the shaft, and the outer ring, which is rigidly secured to the casing.

Electrical current passing through the components of the rolling bearing can damage these components, in particular the rolling elements and the raceways formed on the inner and outer rings. Electrical discharges can also generate vibration.

To overcome these drawbacks, it is known practice to ground or earth the rotary shaft using a grounding brush comprising conductive fibers. The grounding brush is usually mounted within the bore of the casing of the electric motor such that the free ends of the fibers are in radial contact with the outer surface of the rotary shaft.

Due to the conductivity of the fibers, the brush is maintained at the same electrical potential as the casing of the electric motor. The inner and outer rings of the rolling bearing are also at the same electrical potential, which reduces or even eliminates problematic electrical discharges through the rolling bearing.

US Patent Publication No. 2021/0021180 A1 discloses a grounding brush assembly comprising a grounding brush provided with a plurality of conductive fibers, a support inside which the conductive fibers are mounted, and an annular mounting plate comprising a plurality of tabs for radial and axial retention of the support, and an annular outer flange radially surrounding the brush and the tabs.

The tabs for axial and radial retention of the support are formed by cutting and bending a radial portion of the mounting plate which bears axially on the support. In order to create these retention tabs, it is necessary to make large cuts in the radial portion of the mounting plate. These cuts impair or reduce the mechanical strength of the mounting plate vis-à-vis the forces exerted when it is mounted in the bore of the casing of the associated electric motor.

Furthermore, given the bent length of the retention tabs, stresses are concentrated during this bending of the tabs on the support of the brush.

The present invention aims to overcome these drawbacks.

### SUMMARY OF THE INVENTION

The invention relates to a grounding brush assembly comprising a grounding brush provided with a plurality of conductive fibers and with a support inside of which the conductive fibers are mounted. The assembly further comprises a brush mounting plate which is rigidly secured to the support of the brush.

According to a general feature, the mounting plate comprises a plurality of centering tabs for centering the support of the brush.

According to another general feature, the assembly further comprises a plurality of securing means for rigidly securing the centering tabs to the support. The securing means are distinct from the support and from the centering tabs.

With such a design, the bent length of the tabs may be small since they only perform the function of radial centering and not axial retention, which limits the concentration of stresses on the mounting plate. Furthermore, the dimension of the cuts made on the mounting plate for forming the tabs is also small.

Preferably, the securing means are made of an electrically conductive material. As such, the securing means act to further promote the dissipation of electrical charges.

The securing means may comprise glue and/or an adhesive and/or a weld and/or a braze.

According to a first design, each securing means at least partially covers the free end of the associated centering tab and the adjacent area of the support.

According to a second alternative design, each securing means is interposed radially between the associated centering tab and the support.

According to a third design, each securing means covers the free end of the associated centering tab and the adjacent area of the support, and is interposed radially between the associated centering tab and the support.

In one embodiment, the support of the brush includes a mounting portion and two lateral flanks extending from the mounting portion and axially gripping the conductive fibers. One of the lateral flanks of the support may bear axially against the mounting plate.

Preferably, the centering tabs of the mounting plate are axially set back or spaced from the other lateral flank of the support. Such positioning of the tabs further enables forming the tabs with a short length.

The mounting plate may include an annular radial portion against which the grounding brush bears axially. In this case, the lateral flank of the support of the brush may bear axially against the radial portion of the mounting plate.

In a particular embodiment, the centering tabs extend from the radial portion of the mounting plate. Alternatively, the centering tabs may extend from another portion of the mounting plate.

In an embodiment, the mounting plate comprises at least one centering portion extending at least axially from the radial portion, which is offset radially outwardly with respect to the support and has an outer surface defining the outside diameter of the mounting plate.

Preferably, the mounting plate is made in one piece; i.e., of one-piece construction.

The present invention also relates to an electric motor comprising a casing, a shaft and at least one grounding brush assembly as defined above and mounted radially between the casing and the shaft, the conductive fibers of the brush of the assembly being in contact with the shaft.

### BRIEF DESCRIPTION OF THE SEVERAL VIEWS OF THE DRAWINGS

The present invention will be understood more clearly on reading the detailed description of embodiments, provided by way of non-limiting examples and illustrated by the attached drawings in which:

FIG. 1 is a view in axial cross section of a grounding brush assembly mounted radially between a rotary shaft and a casing of an electric motor,

FIG. 2 is a perspective view of a grounding brush assembly according to a first exemplary embodiment of the invention,

FIG. 3 is an end-on view of the grounding brush assembly of FIG. 2,

FIG. 4 is a view in cross section along the axis IV-IV of FIG. 3,

FIG. 5 is a view in cross section of a grounding brush assembly according to a second exemplary embodiment of the invention, and

FIG. 6 is a perspective view of the grounding brush assembly of FIG. 5.

### DETAILED DESCRIPTION OF THE INVENTION

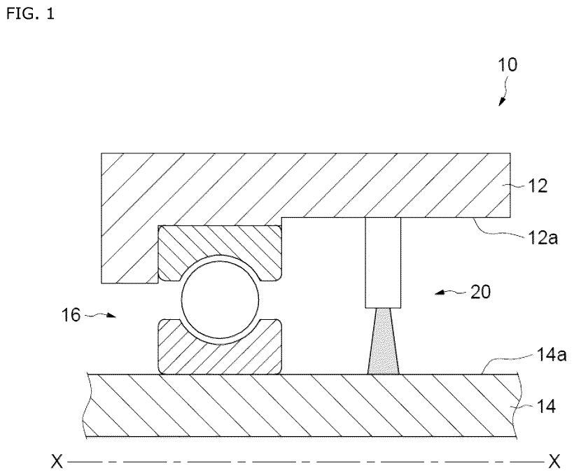

FIG. 1 shows, in axial cross section, part of an electric motor or machine 10 comprising a fixed casing 12, a shaft 14 rotatable about a central axis X-X and a rolling bearing 16 radially supporting the shaft 14. The bearing 14 is shown as a ball bearing, but may alternatively include any other appropriate rolling elements, such as cylindrical rollers, tapered rollers, needles, etc., and may even alternatively be formed as a plain bearing.

The motor 10 further comprises a grounding brush assembly 20 mounted radially between the bore 12a of the casing 12 and the cylindrical outer surface 14a of the rotary shaft 14. The grounding brush assembly 20 provides a continuous dissipation of the electrical charges that build up on the shaft 14 of the motor 10 during motor operation by transferring such charges to the casing 12.

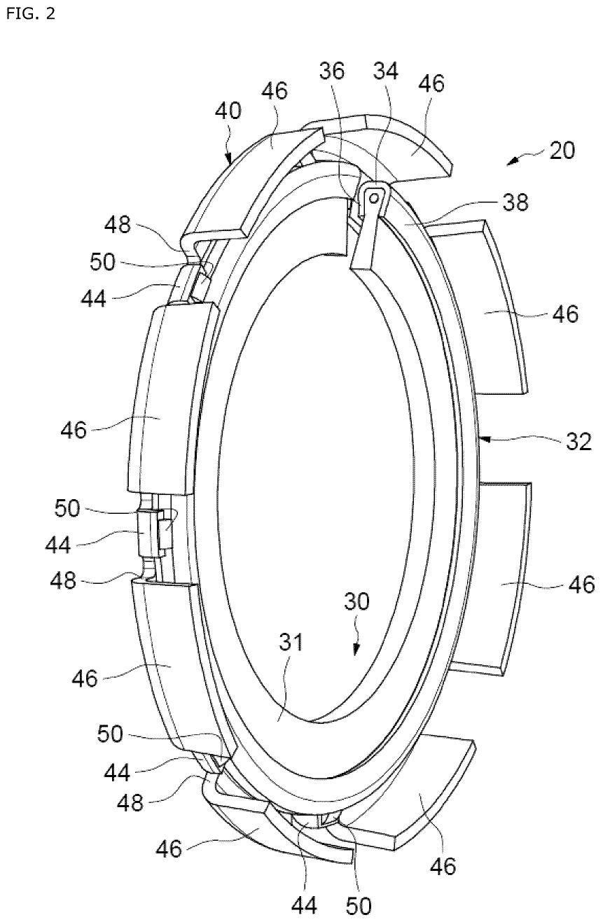

With reference to FIGS. 2 to 4, a grounding brush assembly 20 according to a first example will now be described. The grounding brush assembly 20 has a generally annular shape and basically comprises a grounding brush 30 and a brush mounting plate 40 configured to radially center the brush 30.

As will be described in more detail below, the brush mounting plate 40 is rigidly secured to the brush 30 by added means.

The brush 30 includes a plurality of individual conductive fibers 31 intended to be positioned around the rotary shaft 14 of the motor 10. The conductive fibers 31 may be made of an appropriate electrically conductive material, such as carbon, stainless steel, a conductive plastic such as acrylic or nylon fibers, etc.

The brush 30 further includes a holding member or support 32 inside which the conductive fibers 31 are mounted or disposed. In the depicted exemplary embodiment, the support 32 takes the form of an open ring. The support 32 may be produced by cutting and shaping. The support 32 is made of an electrically conductive material, for example aluminum, stainless steel, bronze, copper or another appropriate material. Alternatively, the support 32 may be made of an electrically non-conductive material with a conductive coating or a conductive paint applied to the support 32.

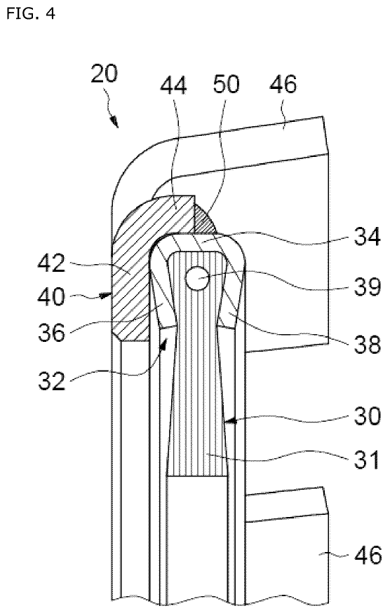

As best shown in FIG. 4, the support 32 includes an axial mounting portion 34 and two opposite lateral flanks 36, 38 extending radially inwardly from the mounting portion 34 and axially gripping the conductive fibers 31, such that the conductive fibers 31 bear axially on either side against the lateral flanks 36, 38. Specifically, the conductive fibers 31 bear axially on either side against the inner faces of the lateral flanks 36, 38.

The mounting portion 34 and the two lateral flanks 36, 38 delimit a channel that is open radially inwardly, inside which the conductive fibers 31 are partially located or disposed.

In the example shown, the conductive fibers 31 are bent around a connecting wire 39 of the support 32. The free distal end of the conductive fibers 31 is intended to come into radial contact with the outer surface of the rotary shaft 14 of the motor 10. The proximal end, or inner radial end, of the conductive fibers 31 is in radial contact with the mounting portion 34 of the support 32.

The lateral flank 36 extends from one axial end of the mounting portion 34 and the lateral flank 38 extends from another, opposite axial end of the mounting portion 34. The lateral flanks 36, 38 extend obliquely inwardly from the mounting portion 34. The lateral flanks 36, 38 are preferably symmetrical with respect to each other about a median radial plane of the support 32. The mounting portion 34 in this case extends substantially axially. Alternatively, the mounting portion 34 could extend obliquely and/or the lateral flanks 36, 38 could be non-symmetrical.

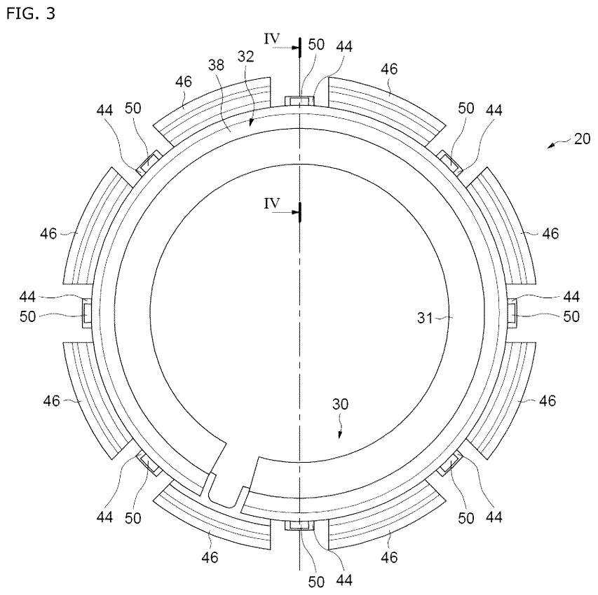

As stated above, the brush 30 is generally formed as an open ring, as best shown in FIGS. 2 and 3. Such an open ring structure allows the brush 30 to adapt to different motor shaft diameters. In general, the ends of the brush 30 are not attached to one another. In a variant, it is possible to attach these ends of the brush 30 to each other.

The mounting plate 40 is preferably fabricated by cutting and shaping. The mounting plate 40 is preferably formed of an electrically conductive material, for example aluminum, stainless steel, bronze, copper or another appropriate material. Alternatively, the mounting plate 40 may be made of an electrically non-conductive material with a conductive coating or a conductive paint applied to the plate 40.

With reference to FIGS. 2 and 4, the mounting plate 40 of the grounding brush assembly 20 includes an annular radial portion 42 and a plurality of centering tabs 44 extending from the radial portion 42.

The radial portion 42 of the mounting plate 40 bears axially against the support 32 of the brush 30. More specifically, the radial portion 42 bears axially against the lateral flank 36 of the support 32.

The tabs 44 are spaced apart from one another in the circumferential direction, in this case regularly or evenly. Alternatively, the tabs 44 may be circumferential spaced irregularly or unevenly. In the depicted exemplary embodiment, the mounting plate 40 includes eight tabs 44. Alternatively, it is possible to provide a greater or lesser number of tabs 44. For example, it is possible to provide the mounting plate 40 with two tabs 44 or at least four tabs 44. Preferably, the mounting plate 40 includes at least two of the centering tabs 44.

Each centering tab 44 protrudes or projects axially relative to the radial portion 42. Each tab 44 radially locally surrounds the support 32 of the brush 30 and is in radial contact with the mounting portion 34 of the support 32. The tabs 44 are preferably formed substantially identical to each other.

As best shown in FIG. 4, each centering tab 44 extends axially from the radial portion 42 of the of the mounting plate 40, locally radially surrounds the support 32 and in radial contact with the support 32. Each tab 44 does not have a bent portion at the free end of thereof. In the depicted exemplary embodiment, each tab 44 is axially set back with respect to the lateral flank 38 of the support 32; i.e., the free end of each tab 44 is located axially between the plate 40 and the lateral flank 38.

The mounting plate 40 of the brush 30 further includes a plurality of centering lugs 46 extending from the radial portion 42 of the plate 40 and are spaced apart from each other in the circumferential direction. As best shown in FIG. 2, a plurality of notches 48 are each formed on the radial portion 42 between each consecutive pair of lugs 46 and are spaced circumferentially apart. The lugs 46 are formed by cutting and bending the radial portion 42, such as by means of a stamping operation.

Each centering lug 46 extends axially from the radial portion 42 of the plate 40. Specifically, the lugs 46 extend obliquely from a large-diameter edge of the radial portion 42. Preferably, the lugs 46 and tabs 44 extend axially from a same side of the mounting plate 40. Alternatively, the tabs 44 may extend axially from one side of the mounting plate 40 and the lugs 46 may extend from an opposite side of the plate 40.

Each centering lug 46 locally radially surrounds and is radially spaced apart from the support 32 of the brush 30. The lugs 46 are offset partially radially outwardly with respect to the tabs 44. The lugs 46 are preferably formed substantially identical to each other. The lugs 46 collectively define an outside diameter of the mounting plate 40. Preferably, each lug 46 extends obliquely, but may alternatively extend substantially axially. Each lug 46 is preferably formed as a portion of a cylinder. The bore of each lug 46 is spaced apart radially from the support 32 by a non-zero radial distance. The outer surfaces of the lugs 46 define the outside diameter of the mounting plate 40. The lugs 46 enable the centering of the mounting plate 40 after mounting the grounding brush assembly 20 within the bore 12a of the casing 12 of the associated electric motor 10.

As shown in FIGS. 2 and 3, the centering lugs 46 are spaced apart from one another in the circumferential direction, in this case regularly or evenly. Alternatively, the lugs 46 may be circumferentially spaced irregularly or unevenly. Each centering lug 46 is located, in the circumferential direction, between two consecutive centering tabs 44 and each lug 46 is spaced apart, in the circumferential direction, from the two immediately adjacent tabs 44. Preferably, each lug 46 has a circumferential dimension greater than a circumferential dimension of each of the tabs 44.

As stated above, the brush mounting plate 40 is rigidly secured to the brush 30.

To secure the plate 40 to the brush 30, the grounding brush assembly 20 further comprises “connectors” or securing means 50 (FIGS. 2 to 4) each associated with a separate one of the centering tabs 44 of the mounting plate and with the support 32. The number of securing means 50 is therefore equal to the number of centering tabs 44.

The securing means/connectors 50 are elements distinct from the tabs 44 and from the support 32, and are added thereto.

In the depicted exemplary embodiment, each securing means 50 is provided between the free end of the associated tab 44 of the mounting plate and the adjacent area of the support 32. More specifically, each securing means 50, or connector 50, is provided between the free end of the associated tab 44 and the adjacent area of the outer surface of the mounting portion 34 of the support 32. Each securing means 50 covers the free end of the associated tab 44 and covers locally the outer surface of the mounting portion 34 of the support 32. Preferably, each securing means/connector 50 includes a weld. Specifically, each centering tab 44 of the mounting plate 40 is in direct radial contact with the mounting portion 34 of the support by being welded thereto. Alternatively, the securing means/connectors 50 may comprise at least one of the following: a glue, an adhesive or a braze.

The support 32 bears axially against the radial portion 42 of the mounting plate 40 and is held in place by the securing means 50. The tabs 44 only function to radial center the brush 30.

Advantageously, each securing means 50 or connector 50 is made of an electrically conductive material so as to promote or enhance dissipation of electrical charges. Thus, the electrical charges that build up on the shaft 14 during the operation of the electric machine 2 are dissipated towards and into the casing 4 through the conductive fibers 31, the support 32 of the brush 30, the securing means/connectors 50 and the mounting plate 40. However, the securing means 50 may be made of an electrically non-conductive material.

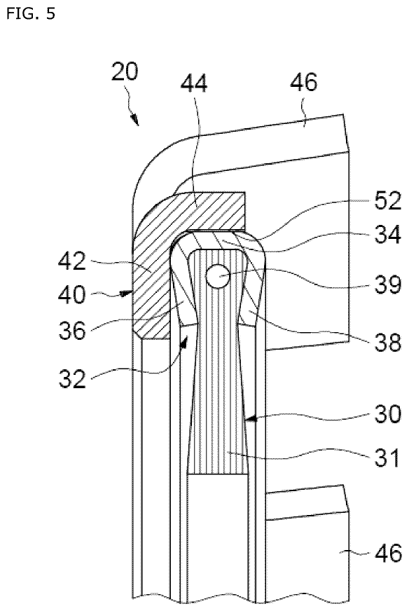

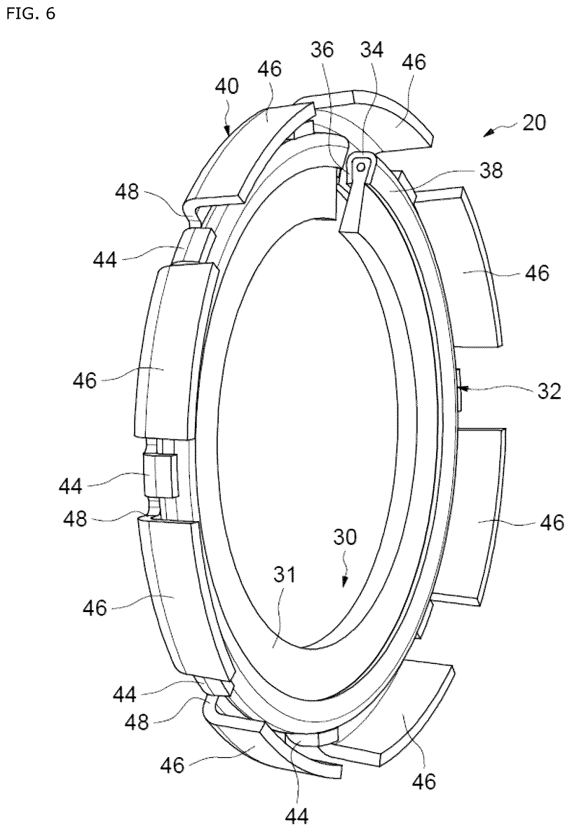

The exemplary embodiment illustrated in FIGS. 5 and 6, in which identical elements bear the same reference numbers, differs from the first example described above mainly in that the grounding brush assembly 20 comprises connectors 52 or securing means 52 interposed radially between each of the centering tabs 44 of the mounting plate 40 and the support 32 of the brush 30. Each securing means/connector 52 is interposed radially between the inner surface of the associated tab 44 and the outer surface of the mounting portion 34 of the support. Each tab 44 is in indirect radial contact with the mounting portion 34 of the support, the associated securing means 52 or connector 52 being interposed radially between them.

In this exemplary embodiment, the centering tabs 44 of the mounting plate 40 have an increased axial dimension. The tabs 44 extend up to the vicinity of the lateral flank 38 of the support and is axially set back relative thereto. Each securing means 52 may comprise glue and/or an adhesive. Preferably, each securing means/connector 52 is made of an electrically conductive material so as to promote the dissipation of the electrical charges, but may alternatively be made of an electrically non-conductive material.

In the embodiments illustrated, the tabs 44 of the mounting plate 40 are axially set back with respect to the lateral flank 38 of the support of the brush 30, such that a free end of each tab 44 is disposed axially between the plate 40 and the lateral flank 38. Alternatively, the tabs 44 could protrude axially with respect to the lateral flank 38 of the support 32. In this case, it may be possible to provide for the securing means/connector 52 associated with each tab 44 to be provided between the inner surface of the tab 44 and the outer surface of the mounting portion 34 of the support 32 and/or the outer face of the lateral flank 38.

In the embodiments described, the tabs 44 of the mounting plate 40 are attached to the support 32 only by the securing means/connectors 50 or 52. Alternatively, it would be possible to provide, in combination with the securing means 50, 52, radial interference of the tabs 44 of the mounting plate 40 against the support 32 such that the mounting portion 34 of the support 32 has in an assembled state, in the area of each retention tab 44, an outside diameter that is smaller or lesser than an outside diameter of the mounting portion 34 in a free, i.e. non assembled, state.

In the depicted embodiments, the mounting plate 40 of the grounding brush assembly 20 includes a plurality of centering lugs 46. Alternatively, the plurality of lugs 46 may be replaced by an annular flange forming an annular centering portion (not depicted).

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A grounding brush assembly comprising:
a grounding brush including a support and a plurality of conductive fibers disposed at least partially within the support;
a brush mounting plate rigidly secured to the support of the brush and including a plurality of centering tabs for centering the support of the brush; and
a plurality of securing means for rigidly securing the centering tabs to the support, the securing means being distinct from the support and from the centering tabs.

2. The grounding brush assembly according to claim 1, wherein the securing means are made of an electrically conductive material.

3. The grounding brush assembly according to claim 1, wherein the securing means include at least one of glue, an adhesive, a weld and a braze.

4. The grounding brush assembly according to claim 1, wherein each securing means at least partially covers a free end of the associated centering tab and an adjacent area of the support.

5. The grounding brush assembly according to claim 1, wherein each securing means is interposed radially between the associated centering tab and the support.

6. The grounding brush assembly according to claim 1, wherein the support of the brush includes a mounting portion and two lateral flanks extending from the mounting portion and axially gripping the conductive fibers, one of the two lateral flanks of the support bearing axially against the mounting plate.

7. The grounding brush assembly according to claim 6, wherein the centering tabs of the mounting plate are set back axially from the other one of the two lateral flanks of the support.

8. The grounding brush assembly according to claim 1, wherein the mounting plate includes an annular radial portion and the grounding brush bears axially against the annular radial portion of the mounting plate.

9. The grounding brush assembly according to claim 8, wherein the centering tabs extend from the radial portion of the mounting plate.

10. An electric motor comprising:
a casing;
a shaft; and
at least one grounding brush assembly according to claim 1 mounted radially between the casing and the shaft, the conductive fibers of the brush of the assembly being in contact with the shaft.

11. A grounding brush assembly comprising:
a grounding brush including a support and a plurality of conductive fibers disposed within the support;
a brush mounting plate rigidly secured to the support of the brush and including a plurality of centering tabs for centering the support of the brush; and
a plurality of connectors each rigidly securing a separate one of the centering tabs to the support, the connectors being distinct from the support and from the centering tabs.
